(19) United States
(12) Patent Application Publication
(10) Pub. No.: US 2012/0075332 A1
(43) Pub. Date: Mar. 29, 2012

(54) Portable storage device and its operating method

(75) Inventors: Hong-Chi Yu, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/137,638

(22) Filed: Aug. 31, 2011

(30) Foreign Application Priority Data
Sep. 24, 2010 (TW) 099132337

(51) Int. Cl. G09G 5/00

(52) U.S. Cl. 345/619

(57) ABSTRACT

A portable storage device along with its operating method comprises a data disc with at least a memory chip and an application program installed into the memory chip. The data disc with superior mobility is provided with a plurality of metal contacts connected to a computer. The application program comprises a screen capture module or a video module, an interception module and a storage space. The present invention could be applied to any computer by one user who intends to record current status shown on a display panel for this action rapidly and conveniently executed. The present invention is effective in not only data on a display panel rapidly and easily recorded but also high transitivity & mobility.

### BACKGROUND OF THE INVENTION

1) Field of the Invention

The present invention relates to a portable storage device and its operating method, especially a portable storage device for a complete image on a computer's display panel fast captured and its operating method.

2) Description of the Prior Art

Image as a computer user's effective means for information expressed has been directly applied to supplying rich information, for instance, texts or any software. To rapidly save a current picture on a computer's display panel, those common methods frequently employed by one computer user include screen capture and video recording by which current status shown on a display panel could be directly and accurately recorded to quickly reflect software status and preserve content not supplied by a copied file.

In general, screen capture or video recording can be completed with a computer's operating system (OS) or specific software for screen capture/video recording. For instance, the steps for “screen capture” based on Microsoft Windows (OS of Microsoft Corporation) comprise (1) Pressing the button “PrintScreen” on a keyboard; (2) Activating graphics software (e.g., MS Paint) on which a captured image is pasted.

The screen capture/video recording technology is mostly applied in immobile electronic products such as personal computer (PC) nowadays. However, those actions for deletion, reproduction, write-in and read-out of digital data or operations of software are common in mobile electronic products such as note book, tablet PC or Personal Digital Assistant (PDA) when information technologies are progressive. Notwithstanding the foregoing, it is still very inconvenient to install software for screen capture/video recoding on a consumer's diversified digital products and to record a picture on an electronic product's display panel with software thereof.

Additionally, it is also inconvenient to download any information by one user which is saved in another owner's electronic product without software for screen capture/video recording installed.

On the other hand, the fact that captured data is difficultly transferred between the electronic products on which software for screen capture/video recording has been installed is another situation disadvantageous to applications.

### SUMMARY OF THE INVENTION

To solve the above problems, the present invention provides a portable storage device along with its operating method wherein the portable storage device comprises a data disc with at least a memory chip and an application program installed in the memory chip. The data disc with superior mobility is equipped with a plurality of metal contacts which can be inserted into a computer. The application program comprises a screen capture module or a video module, an interception module and a storage space: (1) Screen capture module executing screen capture and saving files for captured images; (2) Video module recording content shown on a display panel; (3) Interception module intercepting any output command entered with a keyboard; (4) Storage space storing digital data.

The major object of the present invention is to provide one user a portable storage device along with its operating method by which the user could apply the present invention in any computer. The present invention is effective in not only any data on a display panel rapidly and conveniently recorded by one user who intends to save it but also high transitivity & mobility.

To this end, the present invention has the principal technical measures delivered with the following techniques. The present invention is a portable storage device with an application program and a data disc which comprises a substrate, at least a memory chip and at least a control element wherein the substrate has an inner surface and an outer surface equipped with a plurality of metal contacts, which are used to link the computer, and the memory chip and the control element are installed on the substrate's inner surface. The application program is installed in the memory chip which comprises a screen capture module, an interception module and a storage space: (1) Screen capture module for screen capture and captured content saved in the storage space; (2) Interception module used to intercept an output command entered with a keyboard and taken as a resident program of the computer for interception of a keyboard's output command with the metal contacts connected to the computer; (3) Storage space used in saving digital data.

The purposes and the technical issues with respect to the present invention are further embodied with the following technical measures.

In the said portable storage device, the application program comprises a file format conversion module by which an original file format for captured data can be transferred to another format that can be automatically saved.

In the said portable storage device, the application program comprises a video module used to record, encode and save any image content which is shown on a display panel.

In the said portable storage device, the device could be a flash disc, a hard drive or other storage devices.

In the said portable storage device, the metal contacts are compatible to at least one data transfer interface among Universal-Serial-Bus (USB), Mini Universal-Serial-Bus (Mini USB), Micro Universal-Serial-Bus (Micro USB) or External Serial Advanced Technology Attachment (e-SATA).

In the said portable storage device, the storage space comprises a folder for captured images and a folder for video files, both of which comprise those saved files to be deleted, reproduced, writable, readable and displayed.

Steps for the operating method of a portable storage device in the present invention are: (1) Step a: Metal contacts of the portable storage device connected to a computer; (2) Step b: Electricity conducted; (3) Step c: Interception module as one resident program installed into the computer to intercept a output command entered with a keyboard; (4) Step d: Command for screen capture issued by composite keys on a keyboard; (5) Step e: Command in Step 4 received by the interception module and forwarded to the screen capture module for execution of screen capture. The content shown on the display panel is captured and developed to be bitmap data which can be saved as a file for captured images in the storage space.

The purposes and the technical issues with respect to the present invention are further embodied with the following technical measures.

In the said operating method for the portable storage device, the file for captured images selected after Step e allows its file format to be transferred and automatically saved as another one by the file format conversion module based on a command for format conversion issued by composite keys and later forwarded to the file format conversion module by the interception module.

In the said operating method for the portable storage device, the command for screen capture received by the interception module and informed to the screen capture module after Step d is executed for content on a display panel becoming bitmap data whose format is further converted by the file format conversion module and automatically saved.

In the said operating method for the portable storage device, a command for video recording after Step c is issued by composite keys; the command thereof received by the interception module is forwarded to the video module for recording of any image shown on a display panel, and another command for stopping video recording from composite keys received by the interception module is informed to the video module for termination of video recording and video file saved.

In contrast to prior arts, the present invention used in screen capture/video recording has advantages as follows: (1) high mobility; (2) rapidness & convenience; (3) high-efficient transmission.

### BRIEF DESCRIPTIONS OF THE DRAWINGS

FIG. 1 is the cross-sectional view of a portable storage device in the present invention.

FIG. 2 is the block diagram for the first embodiment of a portable storage device in the present invention.

FIG. 3A is one flow diagram for the first embodiment of operating a portable storage device in the present invention.

FIG. 3B is another flow diagram for the first embodiment of operating a portable storage device in the present invention.

FIG. 4 is the other flow diagram for the first embodiment of operating a portable storage device in the present invention.

FIG. 5 is the block diagram for the second embodiment of a portable storage device in the present invention.

FIG. 6 is the flow diagram for the second embodiment of operating a portable storage device in the present invention.

### DETAILED DESCRIPTIONS OF THE PREFERRED EMBODIMENTS

For objects, characteristics, and effects obviously and easily understood, the preferred embodiments of the present invention are particularly interpreted as follows:

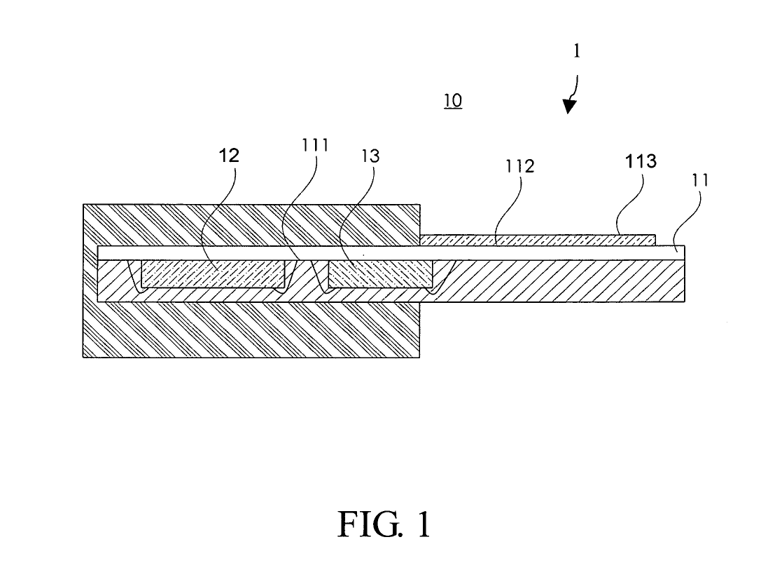

Referring to FIG. 1 which illustrates the major embodiment of the present invention of a portable storage device (1) including, without limitation, a flash disc, a hard drive or other storage devices, which are electrically connected to a computer and receive content shown on a display panel, and comprising a data disc (10) and an application program (20). The computer is one machine based on electronics theories which is capable of processing data according to a series of commands. Despite multiple categories, computers as practical tools to process data in general include, without limitation, mobile devices, PCs, desktops, tablet PCs, servers and Personal Digital Assists (PDA).

Preferably, the data disc could be developed to be a Chip-On-Board (COB) package and comprise a substrate (11), at least a memory chip (12) and at least a control element (13) wherein the substrate (11) has an inner surface (111) and an outer surface (112) and the outer surface (112) is provided with a plurality of metal contacts (113) used in connecting the computer.

Specifically, the metal contacts are compatible to at least one data transfer interface among Universal-Serial-Bus (USB), Mini Universal-Serial-Bus (Mini USB), Micro Universal-Serial-Bus (Micro USB) and External Serial Advanced Technology Attachment (e-SATA). The embodiment herein is based on the metal contacts (113) compatible to Universal-Serial-Bus (USB).

In addition, the memory chip (12) and the control element (13) installed on the inner surface (111) of the substrate (11) could be electrically connected to the inner surface (111) of the substrate (11) by means of a wire bonding or a flip chip technique (not shown in figures).

Specifically, the substrate (11) is usually a high-density double-sided multi-layer printed circuit board with circuits (not shown in the figure) developed inside as an interface for transmit of electricity and allows the metal contacts (113) to be electrically connected to the memory chip (12) and the control element (13) via the substrate (11).

Additionally, the memory chip (12) could be different types of memories, for instance, FLASH, Static-Random-Access-Memory (SRAM), Application-Specific-Integrated-Circuit (ASIC), memory chip or Synchronous-Dynamic-Random-Access-Memory (SDRAM).

Preferably, the inner surface (111) of the substrate (11) is developed to be a package body (14) with the memory chip (12) and the control element (13) encased. Additionally, passive elements (not shown in the figure) necessary to the storage device (1) are also installed on the inner surface (111) of the substrate (11) and encased within the package body (14).

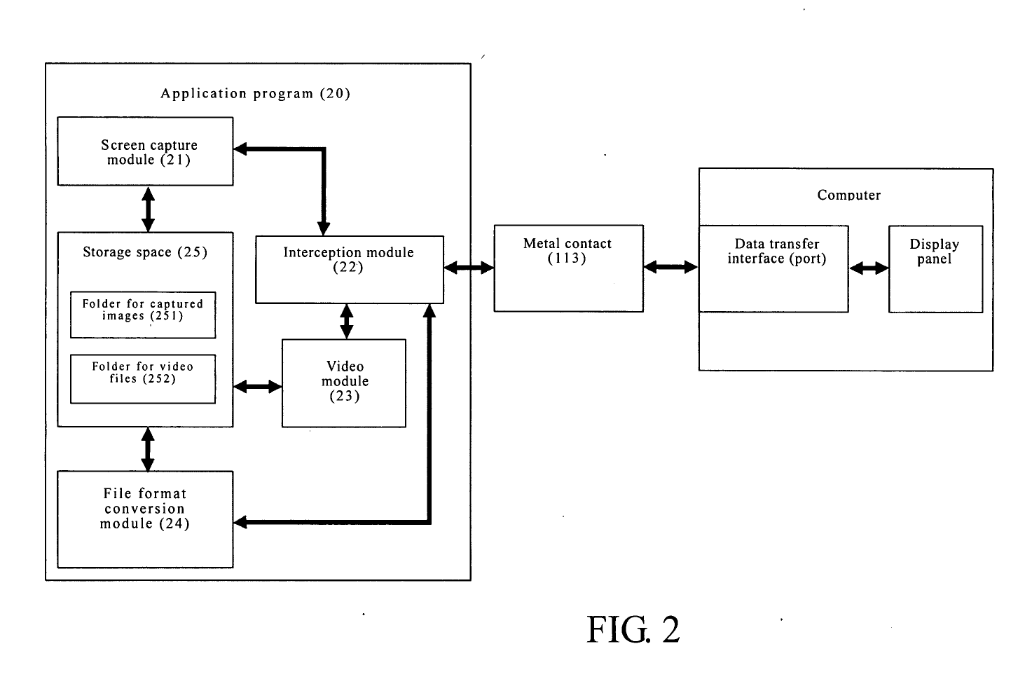

Referring to FIGS. 1 and 2 which illustrate the application program (20) is stored in the memory chip (12) comprising a screen capture module (21), an interception module (22) and storage space (25).

The storage space (25) is used to store digital data and preferably comprises a folder for captured images (251) and a folder for video files (252), both of which have saved files to be deleted, reproduced, writable, readable or displayed.

The screen capture module (21) is used to execute screen capture and save files for captured images in the storage space (25).

The interception module (22) is used to intercept output commands entered with keyboard keys and is one resident program installed into the computer with the metal contacts (113) connected to the computer.

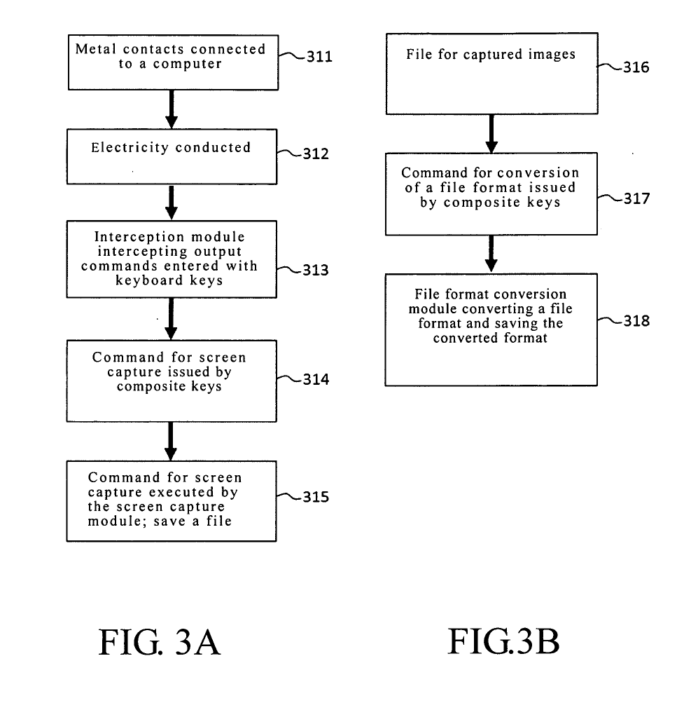

Specifically, the steps to run the embodiment are shown in FIG. 3A: With metal contacts of the portable storage device connected to a computer (311) and electricity conducted (312), the interception module as one resident program is installed into the computer to intercept output commands entered with keyboard keys (313).

In detail, some composite keys have been preset in the interception module for execution of specific commands. One command, e.g., a command for screen capture (314), issued by composite keys and received by the interception module is forwarded to the screen capture module for execution of the command thereof and makes content on a display panel developed to be bitmap data which is further saved as a file for captured images by the screen capture module and stored in the storage space (315).

Preferably, referring to FIG. 2 which illustrates the application program (20) comprises a file format conversion module (24) used in converting an original file format to another format by which the file is automatically saved.

Specifically, referring to FIG. 3B which illustrates operating steps: the file for captured images saved in the storage space by the screen capture module is chosen by one user for conversion of a file format (316); the command for conversion of a file format is issued by composite keys (317) and forwarded to the file format conversion module by the interception module for converting a file format and automatically saving the converted format (318).

Preferably, referring to FIG. 2 which illustrates the application program (20) comprises a video module (23) used in recording, encoding and saving content (or image) shown on a display panel.

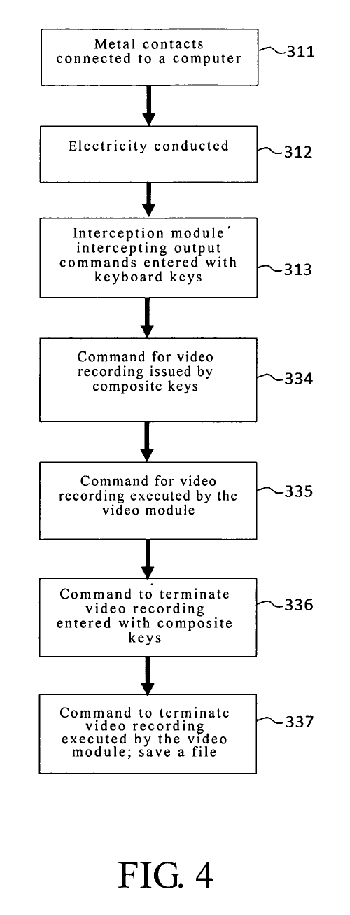

Specifically, referring to FIG. 4 which illustrates operating steps wherein steps described in FIG. 3A and identical to FIG. 4 are marked with the same symbols and not repeatedly interpreted. With the interception module as one resident program installed into a computer and a command for video recording issued by composite keys (334) and received by the interception module, the command is forwarded to the video module for recording content shown on a display panel (335). Next, one command to terminate video recording entered with composite keys (336) and received by the interception module is informed to the video module for termination of video recording and the video file encoded and saved (337). In detail, the saved video files include, without limitation, multiple digital video codes such as FLASHVIDEO FILES (FLV for short), MPEG-4 (MP4 for short), Windows Media Video (WMV for short) and ShockwaveFlash (Swf for short).

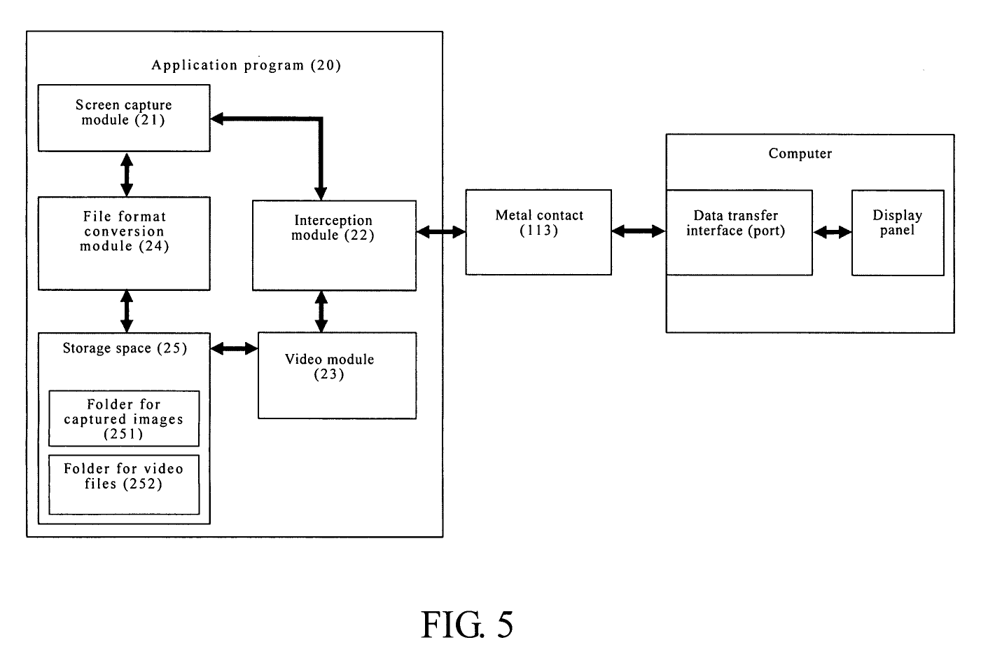

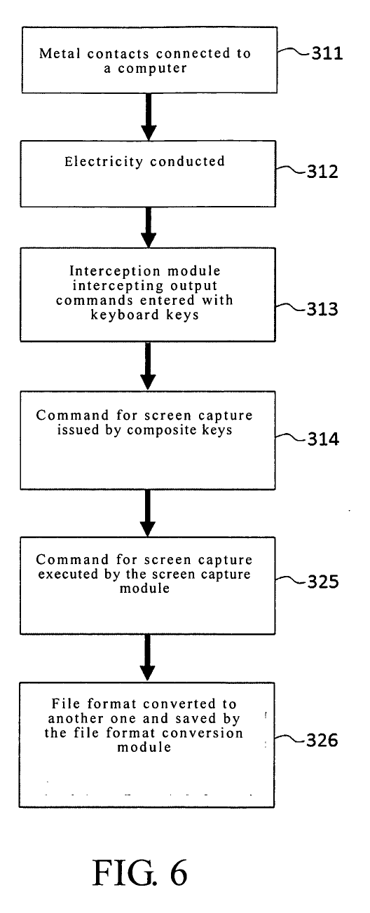

Referring to FIGS. 5 and 6 which illustrate the second embodiment of the present invention wherein structural features and steps identical to the first embodiment and FIGS. 1-4 are marked with the same symbols and not repeatedly interpreted hereinafter.

Referring to FIGS. 5 and 6 which illustrate the second embodiment different from the first one is a command for screen capture (314) from composite keys received by the interception module and informed to the screen capture module for execution of the command thereof and content on the display panel captured and developed to be bitmap data (325) whose file format is converted to another one by the file format conversion module and automatically saved (326). Accordingly, the second embodiment features screen capture and conversion of a file format continuously executed and is distinct from the first embodiment with those operations (i.e., screen capture and conversion of a file format) executed separately.

Referring to FIG. 5 which illustrates the screen capture module (21) executing a command for screen capture followed by the file format conversion module (24) converting and automatically saving a file format that is different from screen capture and conversion of a file format separated each other in the first embodiment. Either the first embodiment or the second embodiment, however, is not used to restrict the present invention, and any change or modification out of the said embodiments conducted by any person skilled in the art without departing from spirit of the present invention or the scope of disclosures and drawings is still within the technical scope protected by the present invention which refers to claims hereinafter.

The present invention provides a portable storage device along with its operating method and is applicable to a user's any computer for the user's action (e.g., recording content shown on a display panel) fast and conveniently executed, recorded data rapidly and easily displayed, and high transitivity and mobility. As a result, the present invention featuring its effects different from general conventional portable storage devices and its test methods referred to as creative work among similar methods meet patentability and is applied for the patent.

It must be stressed that the said disclosures demonstrate the preferred embodiments of the present invention only and any equivalent change in disclosures, claims or drawings with respect to the present invention is still within the technical scope protected by the present invention which refers to claims hereinafter.

What is claimed is:

1. A portable storage device (1) electrically connected to a computer for reception of content on a display panel, comprises:
A data disc (10) comprising a substrate (11), at least a memory chip (12) and at least a control element (13) wherein the substrate (11) has an inner surface (111) and an outer surface (112), the outer surface (112) is equipped with a plurality of metal contacts (113) connected to the computer, and the memory chip (12) and the control element (13) are installed on the inner surface (111) of the substrate (11);
An application program (20) installed in the memory chip (12) which comprises a screen capture module (21), an interception module (22) and a storage space (25); wherein
The screen capture module (21) is able to execute screen capture and save a file for captured images in the storage space (25);
The interception module (22) is used to intercept any output command entered with a keyboard; the interception module (22) as one resident program is installed into the computer to intercept any output command thereof with the metal contacts (113) connected to the computer;
The storage space (25) is used to save digital data.

2. The portable storage device according to claim 1 wherein the application program (20) comprises a file format conversion module (24) used in converting the original format of one file for captured images to another format and automatically saving the converted format.

3. The portable storage device according to claim 1 wherein the application program (20) comprises a video module (23) used in recording, encoding and saving content shown on a display panel.

4. The portable storage device according to claim 1 wherein the portable storage device (1) could be a flash disc, a hard drive or other storage devices.

5. The portable storage device according to claim 1 wherein the metal contacts (113) are compatible to at least one data transfer interface among Universal-Serial-Bus (USB), Mini Universal-Serial-Bus (Mini USB), Micro Universal-Serial-Bus (Micro USB) or External Serial Advanced Technology Attachment (e-SATA).

6. The portable storage device according to claim 1 wherein the storage space (25) comprises a folder for captured images (251) and a folder for video files (252), both of which allow saved files to be deleted, reproduced, writable, readable or displayed.

7. A method to operate the portable storage device with steps comprising:
Step a: Metal contacts of the portable storage device connected to a compute (311);
Step b: Electricity conducted (312);
Step c: Interception module as one resident program installed into the computer to intercept output commands entered with keyboard keys (313);
Step d: Command for screen capture issued by composite keys (314); and
Step e: Command received by the interception module and forwarded to the screen capture module for execution of the command thereof; content on a display panel developed to be bitmap data which is further saved as a file for captured images by the screen capture module and stored in the storage space (315).

8. The method to operate the portable storage device according to claim 7 wherein the file for captured images is selected (316) after Step e and the command for conversion of a file format is issued by composite keys (317) and forwarded to the file format conversion module by the interception module for converting a file format and automatically saving the converted format (318).

9. The method to operate the portable storage device according to claim 7 wherein the command is received by the interception module and informed to the screen capture module for execution of the command thereof after Step d and content on the display panel is captured and developed to be bitmap data (325) whose file format is converted to another one by the file format conversion module and automatically saved (326).

10. The method to operate the portable storage device according to claim 7 wherein one command for video recording issued by composite keys (334) and received by the interception module after Step c is forwarded to the video module for recording content shown on a display panel (335), and another command to terminate video recording entered with composite keys (336) and received by the interception module is informed to the video module for termination of video recording and the video file encoded and saved (337).
